(19) United States
(12) Patent Application Publication
(10) Pub. No.: US 2016/0175853 A1
(43) Pub. Date: Jun. 23, 2016

(54) Centrifuge Feed Accelerator with Feed Vanes

(71) Applicant: APD HOLDINGS, LLC, Durham, NC (US)

(72) Inventors: Jie Zheng, Mansfield, MA (US); Robert B. Carr, Providence, RI (US)

(21) Appl. No.: 14/910,148

(22) PCT Filed: Aug. 7, 2014
(86) PCT No.: PCT/US14/50158

§ 371 Date: Feb. 4, 2016

Related U.S. Application Data
(60) Provisional application No. 61/863,067, filed on Aug. 7, 2013.

(51) Int. Cl. B04B 7/08

(52) U.S. Cl. CPC B04B 7/08

(57) ABSTRACT

A feed accelerator for a centrifugal separator includes a set of vanes or grooves built into its outer surface to define a plurality of channels. Channel openings at the bottom of the accelerator face in the direction of rotation, and the channels curve upwards, aligning with the rotation axis at the top of the accelerator, so as to accelerate the feed liquid from bottom to top of the accelerator. The entry and exit points of the channels are positioned within smoothening zones that promote a circumferentially homogeneous distribution of the feed material. The purpose of this device is to provide minimal shear forces on the channel entrances to minimize shear stress on the feed liquid which can contain fragile solids in suspension. It is intended to be used primarily in automatic piston discharge liquid/solid centrifugal separators.

### RELATED APPLICATION

This application claims priority from U.S. Provisional Application No. 61/863,067, filed Aug. 7, 2013, the disclosure of which is hereby incorporated herein in its entirety.

### BACKGROUND OF THE INVENTION

Centrifugal separators are used for separating heterogeneous mixtures into components based on their specific gravity. A heterogeneous liquid mixture, or feed liquid, is injected into a rotating bowl of a centrifugal separator. The rotating bowl spins at high speed, forcing components of high specific gravity to sediment. As a result, dense solids compress to form a cake or paste against the wall of the bowl, and clarified liquid, or centrate, forms radially inward from the cake. The bowl can spin at speeds sufficient to create an acceleration of 20,000 times the force of gravity, causing separation of the solids from the rest of the feed liquid. As solids accumulate along the wall of the bowl, the centrate exits from the bowl and leaves the separator. In centrifuges that operate in a continuous flow mode, feed liquid is continuously forced into the separator bowl and separated. Once a desired amount of solids has accumulated within the bowl, the separator is placed in a discharge mode in which the solids are removed from the separator.

Most centrifugal separators subject a feed material to high shear forces when the material is introduced into the bowl and accelerated to the rotational speed of the bowl. The loading and acceleration process can damage sensitive chemical or biological substances such as intact cells or proteins. Often, acceleration is accomplished by injecting the feed liquid onto the surface inside of a conical structure or feed cone located at the bottom of the separator bowl. The feed liquid then is accelerated up the surface of the cone and distributed inside the separator bowl, relying on solid-liquid interface friction and liquid viscosity to distribute the feed liquid. Heterogeneities in the distribution of feed material within the separator bowl may arise, however, and add shear stresses as the material mixes with the contents of the bowl. These factors can reduce the efficiency of separation and degrade the biological activity of the material.

There is, therefore, a need for a centrifugal separator system that minimizes the exposure of the material to damaging shear stresses and provides total rotary acceleration of the feed stream to the rotational velocity of the separation pool surface in the centrifuge bowl.

### SUMMARY OF THE INVENTION

In accordance with an embodiment of the present invention, a feed accelerator for a centrifugal separator is disclosed that efficiently, and with a minimum of shear forces being applied, accelerates feed material introduced into the separator up to separation speeds and distributes the material evenly within the separator bowl. The accelerator is compatible with the designs of existing separators, including automatic piston discharge separators, and can be provided as an add-on accessory.

One aspect of the present invention is a feed accelerator for a centrifugal separator. The feed accelerator has a substantially frustoconical form with an inner smooth surface and an outer channeled surface. The feed accelerator is adapted for mounting at the lower end of a separator bowl of the separator. During operation, the feed accelerator accelerates feed liquid through a plurality of feed acceleration channels provided in the outer surface of the accelerator, after which the feed liquid enters the interior of the separator bowl for separation. Each channel in the outer surface of the accelerator has a feed entry port near the lower end of the accelerator and a feed exit port near the upper end of the accelerator. The accelerator outer surface conforms to the inner surface of a feed cone used for loading feed liquid at the lower end of the separator bowl, such that the channels are sealed against the inner surface of the feed cone.

According to some embodiments, a feed accelerator for a centrifugal separator includes bowl portion having a substantially frustoconical shape with a smooth inner surface, an outer surface, an upper portion, and a lower portion. The accelerator includes a plurality of grooves defined in the outer surface, wherein each groove defines a path that runs from a feed entry portion on the outer surface to a feed exit portion that opens in the smooth inner surface of the bowl. The feed entry portion is arranged at a first angle with respect to the lower portion and the feed exit portion is arranged at a second angle, different from the first angle, with respect to the lower portion.

The grooves may curve from the feed entry portion to the feed exit portion. An axis of rotation may be defined through the bowl portion and the feed exit portions of the grooves may be substantially parallel to the rotation axis.

In some embodiments, the plurality of grooves are symmetrically disposed about a circumference of the bowl portion. In some embodiments, each groove comprises an open portion on the outer surface. In some embodiments, each groove comprises a generally semi-circular portion. In some embodiments, the accelerator has an intended direction of rotation and the feed exit portions curve toward the intended direction of rotation.

In some embodiments, the accelerator is sized and configured to fit within a feed cone of a separator. The outer surface of the accelerator may be shaped to fit against an inner surface of the feed cone. The accelerator may include at least one retaining feature configured to engage with a complementary structure of the feed cone to secure the accelerator within the feed cone. The at least one retaining feature may include first and second retaining lips configured to interlock with complementary structures of the feed cone. In some embodiments, the accelerator includes at least one friction ring between the first and second retaining lips. In some embodiments, the channels occupy space between the outer surface of the accelerator and an inner surface of the feed cone.

Other aspects, features, and advantages of the present invention will be apparent from the Detailed Description of the Invention that follows.

### BRIEF DESCRIPTION OF THE DRAWINGS

The invention will be more fully understood by reference to the accompanying drawings of which:

FIGS. 1A and 1B present a perspective and a side view, respectively, of a feed accelerator in accordance with an embodiment of the present invention;

FIGS. 2A and 2B present a top and a bottom view, respectively, of the feed accelerator shown in FIG. 1A;

FIG. 3 is a cutaway view of the feed accelerator shown in FIG. 1A mounted in a feed cone of a centrifugal separator;

FIGS. 4A-4C show sectional views of a centrifugal separator containing a feed accelerator according to an embodiment of the present invention; and

FIGS. 5A-5H show steps in a feed-discharge cycle of a centrifugal separator incorporating a feed accelerator according to an embodiment of the present invention.

### DETAILED DESCRIPTION OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The centrifuge feed accelerator of the present invention provides for the acceleration of sensitive biological materials delivered to the separator bowl of a centrifugal separator (centrifuge) as a feed liquid. The design of the feed accelerator reduces shear stresses applied to the feed material, minimizes loss of solids, and allows the feed liquid to be accelerated to the full rotational speed of the separation pool surface in the bowl. As a result, the entire volume of the bowl is utilized and the efficiency of separation is improved.

As will be described in more detail below, the accelerator is bowl or cone-shaped and includes a plurality of vanes, or open grooves, on the outer surface that, when the accelerator is inserted in a centrifuge, define enclosed channels that run from the outer surface and exit from an inner surface of the accelerator. Thus, each channel provides a conduit from outside to inside the accelerator. It should be noted that vane, groove and channel are used interchangeably in the description to follow with respect to the embodiments of the present invention. Each channel or vane has a lower, or entry, opening located on the outer surface and an upper, or exit, opening that is provided in the inner surface and a shape, or path, that curves upwards, from a bottom edge to an upper edge of the accelerator, i.e., in a modified spiral. As the accelerator will be spinning in application, the lower channel openings all are facing in the same direction of expected rotation. The path of the channel may be considered as a modified spiral because the upper opening portion of each channel is generally aligned with an axis of rotation. Advantageously, this orientation causes the feed liquid to accelerate from bottom to top of the accelerator.

The entry and exit openings of the channels are positioned within smoothening zones that promote a circumferentially homogeneous distribution of the feed material. As the accelerator is intended for operation within a separator, the lower surface of the accelerator cone is configured to interface with, and seal against, an inner surface of a feed cone of the separator, while its upper surface is configured to interface with an optional solids discharge piston if the separator is equipped with such. The accelerator can be removed, cleaned, and sterilized, or can be replaced between separations of different materials. The accelerator also can be incorporated into a disposable, pre-sterilized separator bowl or bowl liner unit.

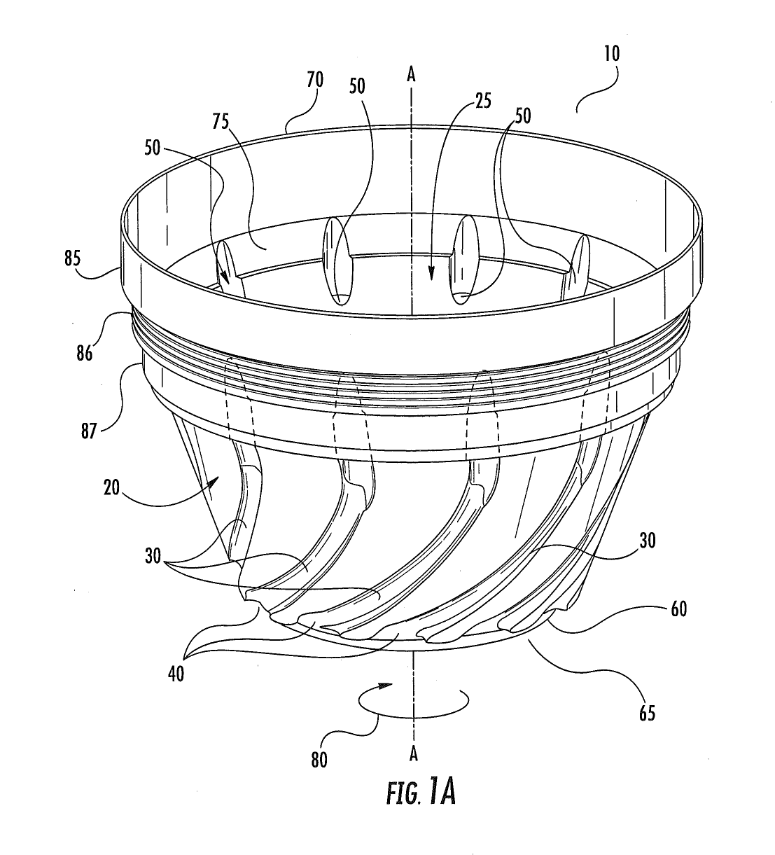

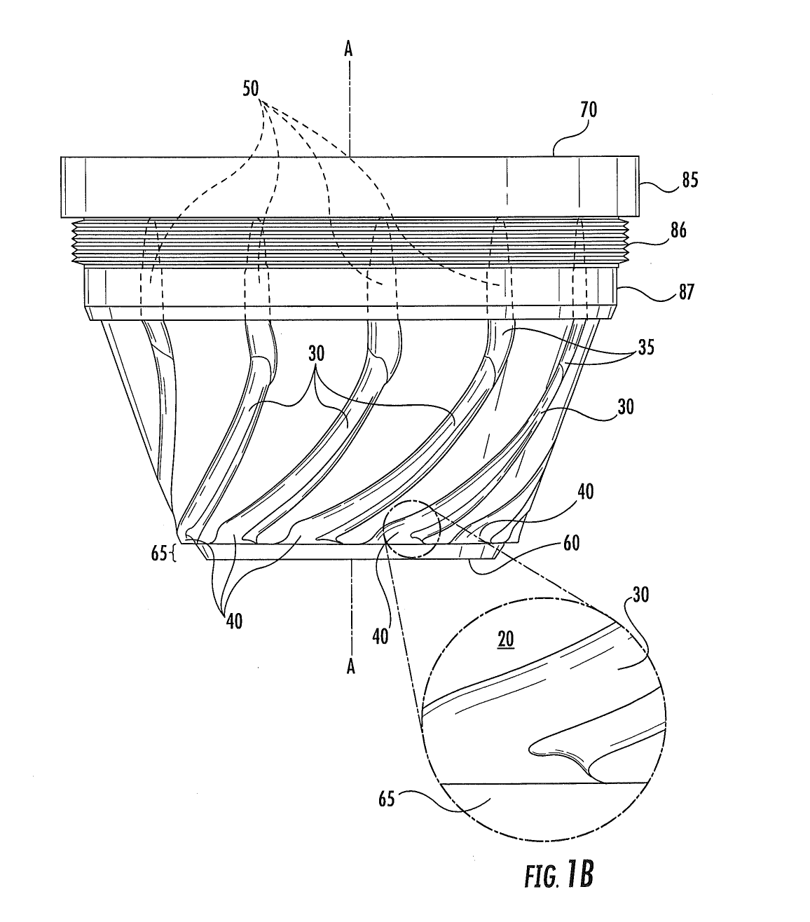

Referring now to FIGS. 1A and 1B, a feed accelerator 10 is generally shaped like a bowl or vase, i.e., generally frustoconical in shape when viewed from the side (FIG. 1B). An outer surface 20 is intended to substantially conform to the inner surface of a feed cone or an analogous structure of the separator, into which the accelerator is positioned during use. An inner surface 25 of the accelerator (FIG. 1A), in one embodiment, is generally smooth. A plurality of channels 30, each having a feed entry port 40, are provided on the outer surface 20. The channels 30 run through the outer surface 20 of the accelerator 10 and come through, at a respective feed exit port 50 near the top of the accelerator 10. The channels 30 can be machined or molded into the outer surface 20. As shown, each channel 30 extends from the feed entry port 40 near a lower edge 60 of the accelerator 10 to the feed exit port 50 near a top edge 70 of the accelerator.

The feed accelerator 10 can include one or more zones that spatially distribute and mix the feed liquid so as to assure its even distribution, i.e., to smooth out the flow of the feed liquid. A lower smoothening zone 65 is a region on the outer surface 20 of the accelerator 10, located, generally, between the lower edge 60 and a protruding edge, on the order of several millimeters, above the lower edge 60, which is, generally, where the feed entry ports 40 are located. The lower smoothening zone 65 provides a space where feed liquid is distributed circumferentially by rotation of the accelerator 10 with the bowl, giving rise to a pool of feed material that is then pushed up into the channels 30 by centrifugal force. The lower smoothening zone 65 assures a more even distribution of feed material among the feed acceleration channels 30 than would be obtained without using a lower smoothening zone. An upper smoothening zone 75 is the region inside the accelerator 10, generally above the feed exit ports 50, and extending to the top edge 70 or near the top edge 70 of the accelerator 10.

In the embodiment shown in FIG. 1A, the upper smoothening zone 75 terminates at a transition band that forms a structural transition between the accelerator 10 and the feed cone by means of a surface that slopes from the inner surface of the accelerator 10 towards the inner surface of the feed cone. This transition band provides an offset from the inner surface of the feed cone that allows the feed exit ports 50 to be set inward from the wall of the feed cone by a distance of, for example, several millimeters.

The feed accelerator 10 can be outfitted with structures needed to fit and retain it within a separator structure, such as a feed cone, or a lower portion of the separator bowl. Thus, for example, as shown in FIGS. 1A and 1B, a first retaining lip 85 and a second retaining lip 87 are provided. Each of the first and second retaining lips 85, 87 are configured to interlock with complementary structures in the feed cone of the separator in order to secure the accelerator 10 within the cone. The fit can be further secured by friction between, for example, a rubber friction ring 86 and the corresponding surface of the separator feed cone. Alternatively, the feed accelerator 10 can be mounted to the feed cone via a threaded (screw-on) connection or by brazing or welding to the feed cone. The outer surface 20 of the accelerator 10 is generally shaped to be pressed against the inner surface of the feed cone or other mounting structure, and the fit should be tight enough that feed liquid is retained within the acceleration channels 30 without leaking out of the channels 30.

The feed acceleration channels 30 are distributed around the outer surface 20 of the accelerator 10, as shown in FIGS. 1A and 1B. The number of channels 30 can be, for example, from 4 to 24 depending on the system needs and the size of the accelerator 10. In one embodiment, the channels 30 are distributed at equal intervals around the circumference of the accelerator 10 to ensure good balance and avoid vibration during high speed operation as the vessel spins about an axis A-A.

Each of the channels 30 is arranged such that the feed entry ports 40 face into an intended rotation direction of the accelerator 10. A leading edge of the vane, which defines a channel when the accelerator is in position, catches and redirects the liquid feed into the channel. Advantageously, if some feed is missed, it will be redirected to, and caught by, the next opening to spin by. Each channel 30 curves gradually upwards, i.e., in a direction from the bottom edge 60 toward the top edge 70 such that the channel 30, and the feed exit port 50, are substantially aligned, i.e., parallel, with the rotation axis A-A. The curvature of the channels 30 ensures that there is a gradual transition from angular acceleration to vertical acceleration of the feed. The angle of the channels 30 with respect to the base of the accelerator 10 at any given point along the channel can be, for example, from about 5 to 15 degrees at the feed entry port 40 to about 90 degrees, i.e., parallel to the axis A-A. A final portion 35 of each channel 30, corresponding with the exit port 50, is substantially vertically oriented, i.e., 90 degrees, or parallel to the axis A-A as shown in FIG. 1B. Advantageously, this arrangement of the channels 30 orients the feed liquid to leave the feed exit ports 50 with vertical momentum that carries the feed liquid upwards into the separator bowl.

In another embodiment of the present invention, the feed exit ports 50 curve back into the intended direction of rotation and, therefore, are not aligned with, or parallel to, the axis A-A. As a result, because the feed liquid is being released “into” the rotation, it will be directed back and substantially align with the axis A-A.

Each channel or vane 30 provided in the outer surface is rounded in order to avoid shearing, i.e., damaging, cells in the liquid feed. More specifically, each channel has a cross-sectional profile that is rounded or semi-circular, at the innermost section of the channel.

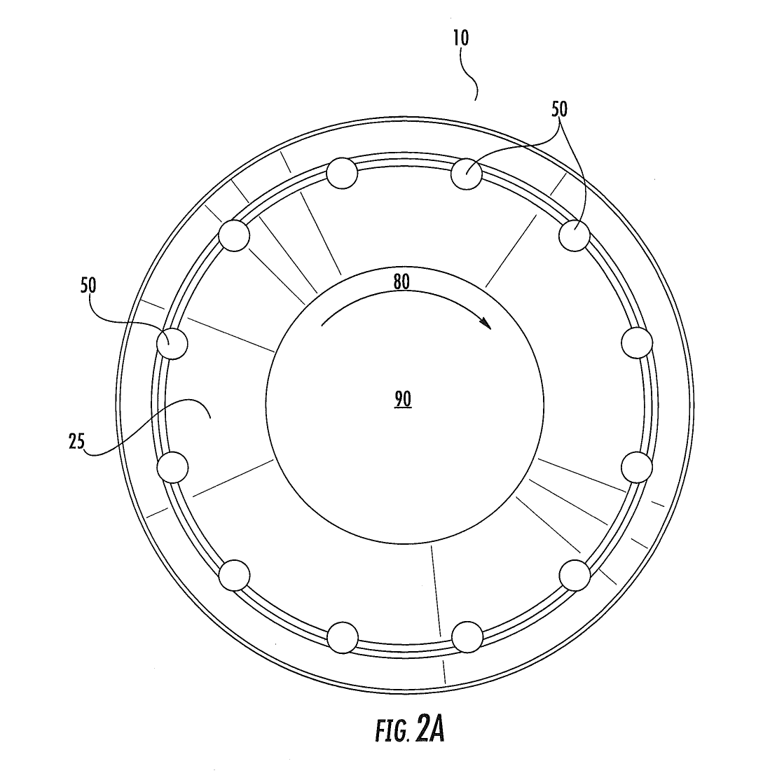

As shown in FIG. 2A, a top-down view of the feed accelerator 10, a lower central opening 90 is provided at the center and allows for a broad path for the bulk discharge of solids through the bottom of the feed cone, i.e., for collection during a solids discharge cycle. The regularly distributed or spaced exit ports 50 are also visible.

Referring now to FIG. 2B, a view of the feed accelerator 10 from the bottom generally presents a distribution and shape of the channels 30. An arrow 80 indicates the intended direction of rotation during use and, therefore, the feed entry ports 40 “lead” the feed exit ports 50 in rotation.

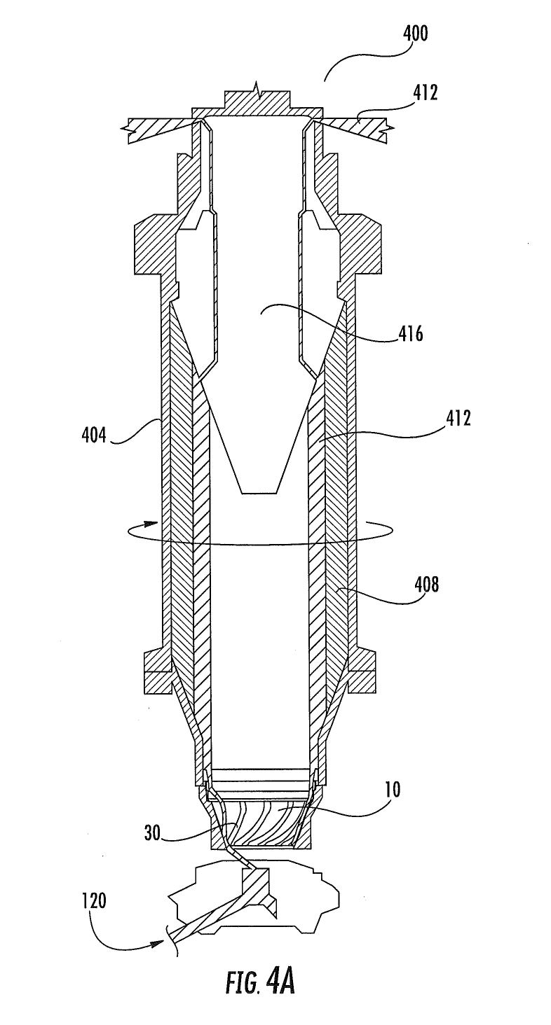

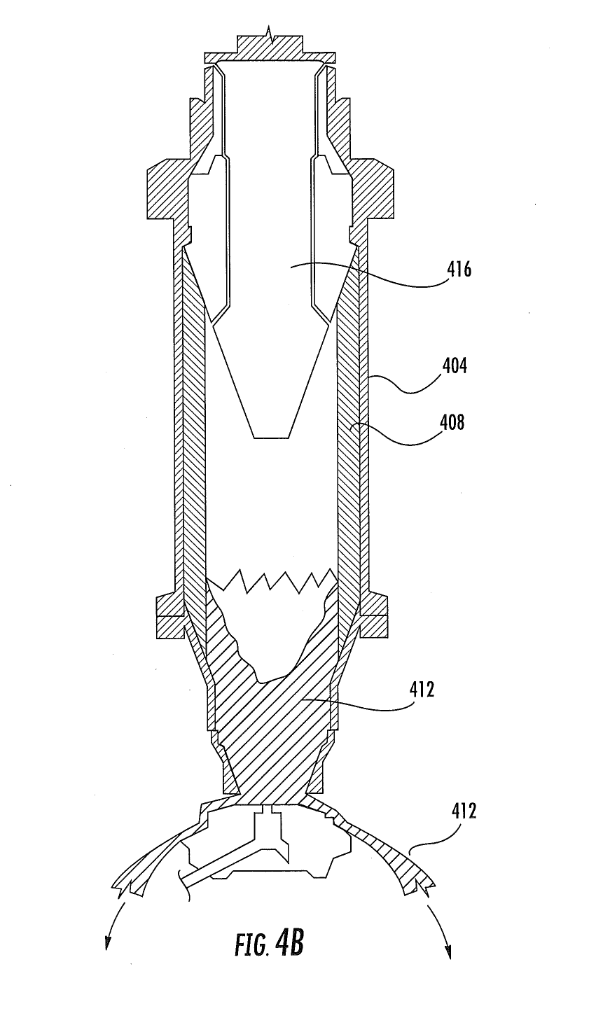

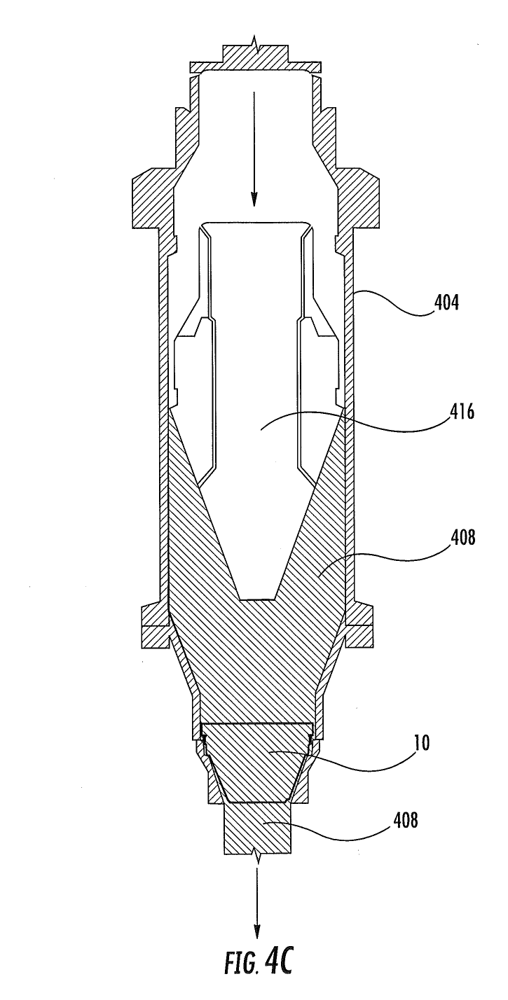

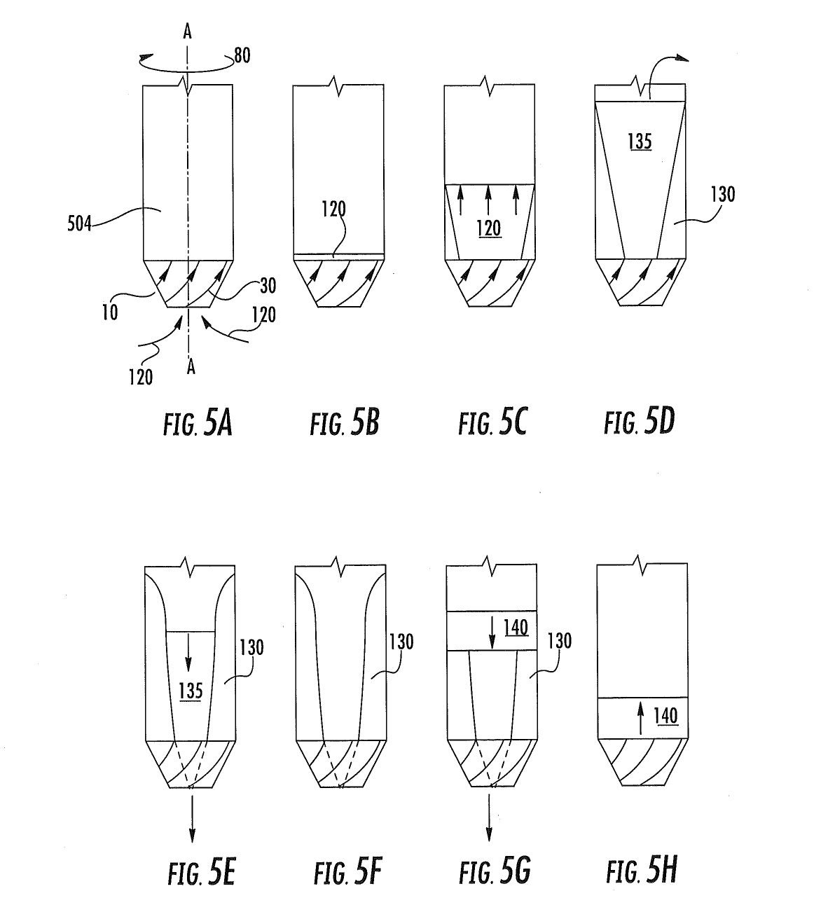

As discussed above, the accelerator 10 is intended for use in a centrifugal separator. A conceptual description of one manner of operation of the use and function of a feed accelerator 10 according to the present invention through a cycle of operation in a centrifugal separator is represented in FIGS. 5A-5H. As shown in FIG. 5A, a feed liquid 120 is loaded into a separator bowl 504 through the channels 30 of the feed accelerator 10. Loading can be accomplished, for example, by pumping the feed liquid 120 into a feed port of the separator or applying pressure to the feed liquid in a reservoir connected to such a feed port (not shown). The separator bowl 504, including the feed accelerator 10, is rotating 80 at a high rate during the loading of the feed liquid 120. As described above, the rotation of the bowl 504 and the accelerator 10 provides centrifugal force, which is the driving force for migration and distribution of the feed liquid 120 within the bowl 504 and the accelerator 10. The feed liquid 120 travels upward and outward through the channels 30 and exits through the feed exit ports 50 in the accelerator 10, eventually forming a pool of feed liquid 120 above the accelerator 10, within a feed cone and separator bowl 504, as shown in FIG. 5B. Essentially, the feed liquid 120 is moved from the outer surface 20 of the accelerator 10 to the inner surface 25 where the feed liquid 120 is then moving generally parallel to the spin axis A-A of separator. As loading of the feed liquid 120 continues the level of feed liquid 120 rises and fills the interior surface of the separator bowl 504, as shown in FIG. 5C.

Once the bowl 504 has filled to an appropriate level, the rotation speed is increased to the separation speed, and separation begins. A solid material 130, shown in FIG. 5D, begins to accumulate on the wall of the bowl 504, while a solids-poor centrate fluid 135 accumulates at the center of the bowl 504, FIG. 5D, and can be collected and removed from the top of the bowl 504 through a centrate port (not shown). During separation, the feed liquid 120 can be continuously pumped in through the feed accelerator 10, operating in a continuous separation mode; alternatively, separation can proceed using just the contents of the bowl 504, without further influx of the feed liquid 120 during the separation.

When separation is completed, e.g., when the separator bowl 504 has accumulated sufficient solids, the loading of the feed liquid 120 through the feed accelerator 10 is stopped and the rotation of the separator bowl 504 stops. The residual centrate fluid 135 is drained from the bowl 504, as shown in FIG. 5E, leaving accumulated solids 130 on the wall of the bowl 504 as shown in FIG. 5F. During a solids discharge cycle, a piston 140 is moved downwards in the bowl 504, e.g., under pressure of a driving fluid exerted from above the piston 140. The separated solid material 130, such as harvested cells, is collected through a lower opening in the feed cone, as shown in FIG. 5G.

It should be noted that, as solids are collected, some solid material can become entrapped within the channels 30 of the feed accelerator 10. In one embodiment of the present invention, therefore, a total channel volume is minimized. Additionally, any trapped solids in the feed accelerator 10 will be removed during the next feed cycle by centrifugal force and flow of the feed liquid. To facilitate solids discharge and cleaning, a solids valve (not shown) attached below the opening of the feed cone can be opened in order to create a path for high viscosity materials, such as the collected solids, to be recovered.

Following a solids discharge operation, or a cleaning operation, the discharge piston 140 is raised back to its starting position, FIG. 5H, so that another separation cycle can be carried out.

The feed liquid 120 can be any fluid material that is intended for separation in a centrifuge. Generally, the feed liquid 120 is a suspension of solid particles, such as cells or cellular constituents, in an aqueous medium. The design of the feed accelerator 10 can be adjusted according to the nature of the feed liquid 120 it is intended to be used with. For example, the diameter and/or length of the feed channels 30 can be chosen to accommodate the viscosity of the feed liquid 120, with greater diameter channels and/or shorter channel length used for more viscous samples. Channel diameter or cross-section is also a factor in determining the maximum practical flow rate, because a smaller channel diameter or cross section provides greater resistance to flow. The diameter of the feed acceleration channels 30 vary according to the machine size. While a larger channel cross-section can promote a higher flow rate and less shear stress on the feed material 120, the entrapment of solids at the end of a solids discharge cycle will be greater, and the yield of solids recovery reduced, with a larger channel cross-section. The loss of solids materials due to entrapment within the acceleration channels 30 of the feed accelerator 10 is determined by a ratio of the volume of the channels 30 to a total volume of accumulated solids just prior to initiating the solids discharge cycle.

Referring now to FIG. 3, a partial, cutaway view of a feed cone 100 of a centrifugal separator is shown with the feed accelerator 10 positioned within the feed cone 100 for use during loading, acceleration, and solids collection, as has been described above. In this embodiment, the feed accelerator 10 occupies approximately the lower half of the feed cone 100 although this ratio may be adjusted depending on the system needs. The feed accelerator 10, in one embodiment, is positioned at a lower end of the feed cone 100 so that feed liquid 120 enters at the lower end 60 of the accelerator 10, which has the smallest diameter of the accelerator 10, and is accelerated up towards the upper end 70 of the accelerator 10, which has the largest diameter. In one embodiment, the channels 30 extend as close as possible to a minimum radius of the liquid pool in the bowl. The channels occupy space between the outer surface of the accelerator 10 and inner surface of the feed cone. The feed liquid 120 enters the channels 30 under the lower edge 60 of the accelerator 10, and is then pushed through the channels 30, via the entry ports 40 and up and out through the exit ports 50 into the feed cone 100, which constitutes the lower section of the separator bowl. During a solids discharge cycle, the feed cone 100 accepts the discharge piston at its lower limit of travel, so that accumulated solids are ejected through the feed cone via the lower central opening 90 of the accelerator 10.

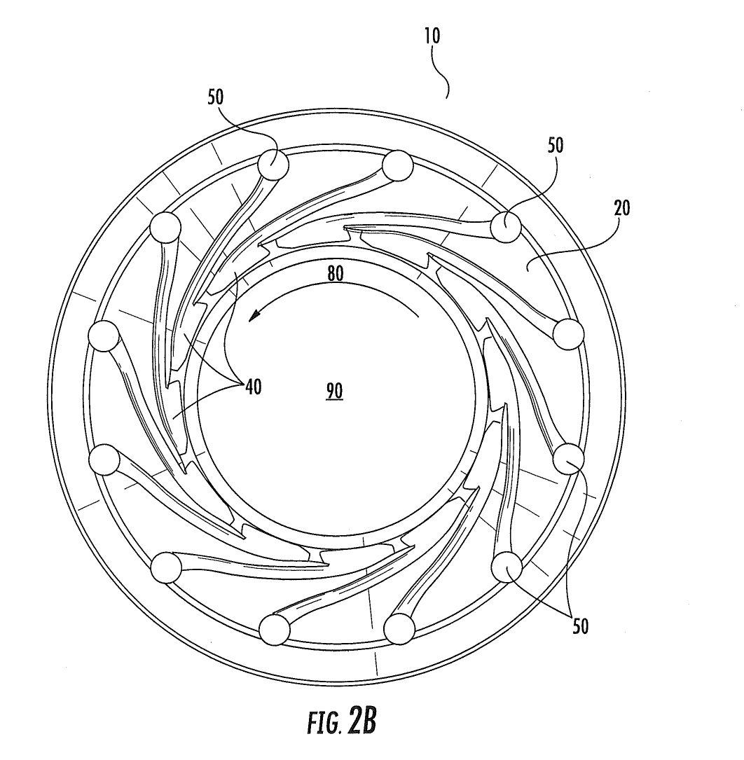

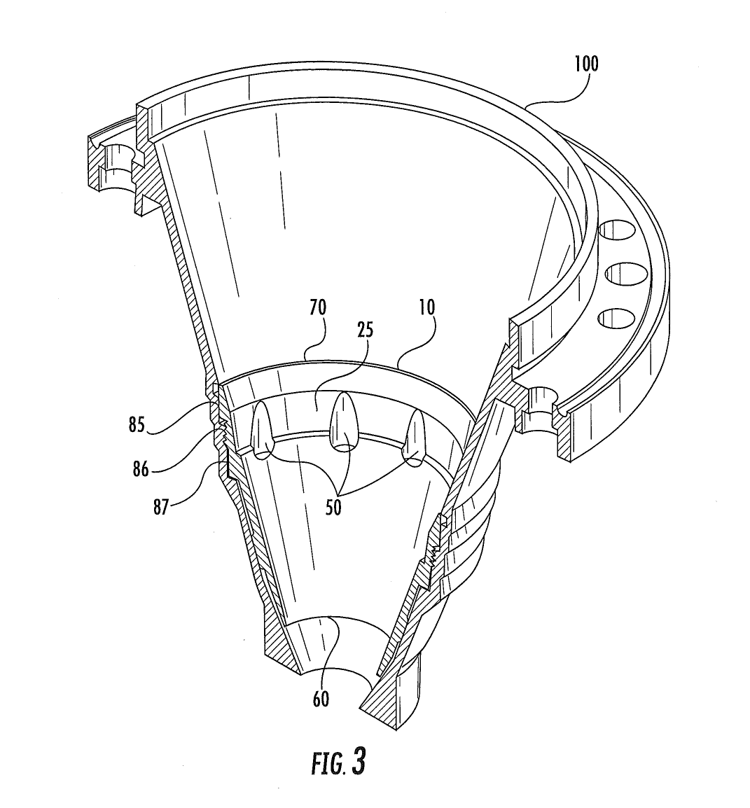

Referring now to FIGS. 4A-4C, a solids discharge centrifugal separator 400 includes a feed accelerator 10 positioned near its base. The separator 400 includes a separator bowl 404 that spins as described above. The feed liquid 120 is provided up through the accelerator 10, as described above, to provide the feed liquid 120 into the separator bowl 404. As the feed liquid 120 spins, it separates into a solids cake 408 that is pushed against the wall of the bowl 404. A centrate fluid 412 then remains within the bowl 404. In one mode of operation, the centrate fluid 412 may be decanted through pathways provided in a piston 416, as shown.

When the separation operation is completed and the spinning has ceased, remaining centrate fluid 412 is then drained away through a base of the separator 400, through the accelerator 10. Once the centrate fluid 412 has been drained, the piston 416 is pushed “down,” i.e., toward the exit port of the separator 400, to discharge or extrude the accumulated solids 408 through an opening at the lower end of the separator bowl 404.

The separator 400 shown in FIGS. 4A-4C is referred to as providing a “clean in place” operation. In one embodiment, the separator bowl 404 has a lower section that forms a feed cone and contains the feed accelerator 10. The accelerator 10 can be used with other designs for solids discharge, e.g., using a scraper instead of a piston inside the bowl, or can be used in separator designs that do not provide for solids discharge, e.g., separators having no solids removal mechanism inside the bowl.

In addition, the accelerator 10 and the piston 416 are sized and configured to complement one another in order to scrape as much solids 408 away as possible.

The feed accelerator 10 according to the various embodiments of the present invention can be fabricated from any material compatible with the structural requirements of separation as well as the biocompatibility requirements of the feed material. For example, the feed accelerator can be fabricated from a strong lightweight metal or alloy such as stainless steel, or titanium, or from a polymer material such as polyether ether ketone (PEEK) or Ultem® Polyetherimide (PEI) or the like. Fabrication methods can include machining a metal or plastic stock, injection molding a thermoplastic plastic material, or any combination thereof.

While the present invention has been described in conjunction with a number of embodiments, one of ordinary skill in the art, after reading the foregoing specification, will be able to effect various changes, substitutions of equivalents and other alterations to the compositions, articles, methods and apparatuses set forth herein. For example, fluid pressure may be replaced in other embodiments by, without limitation, an electromechanical force. Similarly, the lower portion and end of the piston and bowl, respectively, may be non-conical in shape, although it is advantageous for solids recovery that their shapes be complimentary. Valves can be operated manually or by, e.g., electrically or pressure-driven actuators. Solids discharge may be activated through other compatible structures or operations, e.g., a scraper operating within the bowl that removes accumulated solids from the inner wall.

Moreover, embodiments of the present invention also contemplate that the various passages, valves, pistons, actuators, assemblies, ports, members and the like described herein can be in any configuration or arrangement that would be suitable for operation of a centrifugal separator. The embodiments described above may also each include or incorporate any of the variations of all other embodiments. For example, the centrifugal separator can be hermetically sealed or can lack hermetic seals, or can have disposable sample contact components such as a bowl liner, or can be designed for cleaning between runs and reuse. Various components, e.g., bowls, bowl liners, pistons, or valves, can be provided as separate items or combined with related items as a kit, including instructions for use with a separator or a method according to the invention. Furthermore, the embodiments described herein may also include any of the components or configurations described in any of U.S. Published Patent Application Nos. 2010-0167899, 2007-0049479 and 2007-0114161, and U.S. Pat. Nos. 7,261,683, 7,052,451, and 6,986,734, all of which are incorporated by reference herein for all purposes. It is therefore intended that the protection granted by Letter Patent hereon be limited only by the definitions contained in the appended claims and equivalents thereof.

What is claimed is:

1. A feed accelerator for a centrifugal separator, the feed accelerator comprising:
a bowl portion having a substantially frustoconical shape with a smooth inner surface and
an outer surface, an upper portion, and a lower portion; and
a plurality of grooves defined in the outer surface, wherein each groove defines a path that runs from a feed entry portion on the outer surface to a feed exit portion that opens in the smooth inner surface of the bowl,
wherein the feed entry portion is arranged at a first angle with respect to the lower portion and the feed exit portion is arranged at a second angle, different from the first angle, with respect to the lower portion.

2. The feed accelerator of claim 1, wherein the grooves curve from the feed entry portion to the feed exit portion.

3. The feed accelerator of claim 2, wherein an axis of rotation is defined through the bowl portion and the feed exit portions of the grooves are substantially parallel to the rotation axis.

4. The feed accelerator of claim 1, wherein the plurality of grooves are symmetrically disposed about a circumference of the bowl portion.

5. The feed accelerator of claim 1, wherein each groove comprises an open portion on the outer surface.

6. The feed accelerator of claim 1, wherein each groove comprises a generally semi-circular portion.

7. The feed accelerator of claim 1, wherein the accelerator has an intended direction of rotation and the feed exit portions curve toward the intended direction of rotation.

8. The feed accelerator of claim 1, wherein the accelerator is sized and configured to fit within a feed cone of a separator.

9. The feed accelerator of claim 8, wherein the outer surface of the accelerator is shaped to fit against an inner surface of the feed cone.

10. The feed accelerator of claim 9, further comprising at least one retaining feature configured to engage with a complementary structure of the feed cone to secure the accelerator within the feed cone.

11. The feed accelerator of claim 10, wherein the at least one retaining feature comprises first and second retaining lips configured to interlock with complementary structures of the feed cone.

12. The feed accelerator of claim 11, further comprising at least one friction ring between the first and second retaining lips.

13. The feed accelerator of claim 8, wherein the channels occupy space between the outer surface of the accelerator and an inner surface of the feed cone.
